(19) United States
(12) Patent Application Publication
(10) Pub. No.: US 2023/0254202 A1
(43) Pub. Date: Aug. 10, 2023

(54) APPARATUS AND METHOD FOR PROVIDING EDGE COMPUTING SERVICE IN WIRELESS COMMUNICATION SYSTEM

(71) Applicant: SAMSUNG ELECTRONICS CO., LTD., Suwon-si (KR)

(72) Inventors: Cheolung LEE, Suwon-si (KR); Hyesung KIM, Suwon-si (KR)

(21) Appl. No.: 18/163,749

(22) Filed: Feb. 2, 2023

(30) Foreign Application Priority Data
Feb. 4, 2022 (KR) 10-2022-0015010

(51) Int. Cl. H04L 41/0803; H04L 41/12

(52) U.S. Cl. CPC H04L 41/0803; H04L 41/12; H04W 84/042

(57) ABSTRACT

The disclosure relates to a 5G or 6G communication system for supporting a higher data transmission rate. According to various embodiments, a method performed by an edge enabler server (EES) in a mobile communication system, the method comprising: receiving, from a first edge application server (EAS), a registration request message including an indicator indicating whether the first EAS provides a federation function; receiving, from the first EAS, a discovery request message for a second EAS requested by the first EAS; identifying the second EAS based on the discovery request message; and transmitting, to the first EAS, a discovery response message including context information on the identified second EAS, wherein the context information on the second EAS includes an indicator indicating whether the second EAS provides the federation function.

### CROSS-REFERENCE TO RELATED APPLICATION

This application is based on and claims priority under 35 U.S.C. § 119 to Korean Patent Application No. 10-2022-0015010, filed on Feb. 4, 2022, in the Korean Intellectual Property Office, the disclosure of which is herein incorporated by reference in its entirety.

### BACKGROUND

### 1) Field

The disclosure relates generally to a wireless communication system and, more specifically, to an apparatus and a method for providing an edge computing service in a wireless communication system.

### 2) Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (Bandwidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

In accordance with the above discussion, the disclosure provides an apparatus and a method for providing an edge computing service in a wireless communication system.

Various embodiments provide an operation method of an EAS in a wireless communication system, the method including: transmitting a federated EAS discovery request message to an EES; receiving a federated EAS discovery response message including context information of a federated EAS from the EES; and performing communication related to a federated EAS service with the federated EAS, based on the context information.

Various embodiments provide an apparatus of an EAS in a wireless communication system, the apparatus including a transceiver and at least one processor, wherein the at least one processor is configured to: transmit a federated EAS discovery request message to an EES; receive a federated EAS discovery response message including context information of a federated EAS from the EES; and perform communication related to a federated EAS service with the federated EAS, based on the context information.

An apparatus and a method according to various embodiments may provide an apparatus and a method for providing an edge computing service in a wireless communication system.

Advantageous effects obtainable from the disclosure may not be limited to the above mentioned effects, and other effects which are not mentioned may be clearly understood, through the following descriptions, by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to various embodiments of the present disclosure;

FIG. 2 illustrates a configuration of a network entity in a wireless communication system according to various embodiments of the present disclosure;

FIG. 3 illustrates a method for maintaining a federated EAS service session in a different EDN when ACR occurs due to mobility of a terminal in wireless communication system according to various embodiments of the present disclosure;

FIG. 4 illustrates an example of a procedure of an EES to obtain a target EAS (hereinafter, T-EAS) supporting a federated EAS and provide a federated EAS context to a source EAS (hereinafter, S-EAS) in a wireless communication system according to various embodiments of the present disclosure;

FIG. 5 illustrates an example of a procedure of an EES to obtain an EAS (F) supporting a federated EAS and provide a federated EAS context to an EAS in a wireless communication system according to various embodiments of the present disclosure;

FIG. 6 illustrates an example of a procedure of an EES to obtain an EAS (F) supporting a federated EAS and provide a federated EAS context to an EAS in a wireless communication system according to various embodiments of the present disclosure;

FIG. 7 illustrates an example of a procedure of an EES to obtain an EAS (F) supporting a federated EAS and provide a federated EAS context to an EAS in a wireless communication system according to various embodiments of the present disclosure;

FIG. 8 illustrates an example of a procedure of an EES to obtain an EAS (F) supporting a federated EAS and provide a federated EAS context to an EAS in a wireless communication system according to various embodiments of the present disclosure; and

FIG. 9 illustrates an example of a procedure of an EES to obtain an EAS (F) supporting a federated EAS and provide a federated EAS context to an EAS in a wireless communication system according to various embodiments of the present disclosure.

### DETAILED DESCRIPTION

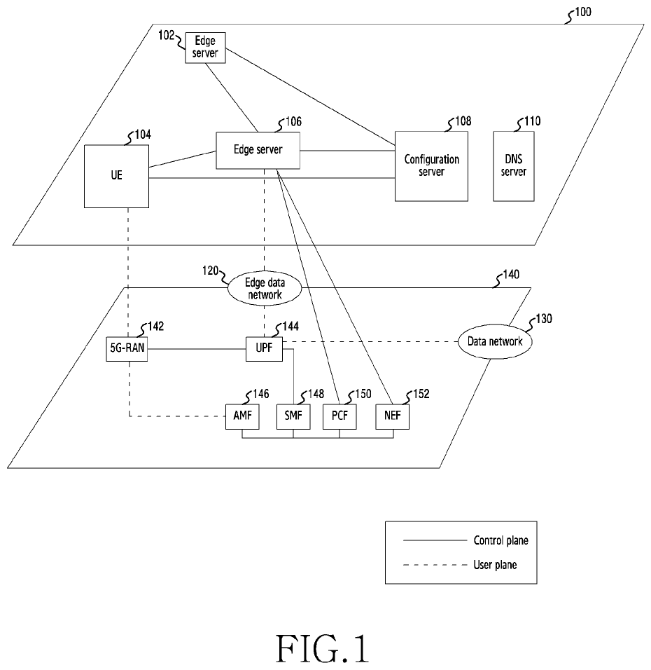

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The terms used in the disclosure are only used to describe specific embodiments, and are not intended to limit the disclosure. A singular expression may include a plural expression unless they are definitely different in a context. Unless defined otherwise, all terms used herein, including technical and scientific terms, have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

Hereinafter, various embodiments of the disclosure will be described based on an approach of hardware. However, various embodiments of the disclosure include a technology that uses both hardware and software, and thus the various embodiments of the disclosure may not exclude the perspective of software.

In the following description, terms referring to signals, terms referring to channels, terms referring to control information, terms referring to network entities, terms referring to data stored in network entities, terms referring to messages transmitted/received between entities, terms referring to device elements, and the like are illustratively used for the sake of convenience. Therefore, the disclosure is not limited by the terms as used below, and other terms referring to subjects having equivalent technical meanings may be used.

Furthermore, in the disclosure, various embodiments will be described using terms employed in some communication standards (e.g., 3rd generation partnership project (3GPP)), but they are only for the sake of illustration. The embodiments of the disclosure may also be easily applied to other communication systems through modifications.

To meet the demand for wireless data traffic having increased since deployment of 4th generation (4G) communication systems, efforts have been made to develop an improved 5th generation (5G) or pre-5G communication system. Therefore, the 5G or pre-5G communication system is also called a “beyond 4G network” communication system or a “post long term evolution (post LTE)” system.

The 5G communication system is considered to be implemented in ultrahigh frequency (mmWave) bands (e.g., 60 GHz bands) so as to accomplish higher data rates. To decrease propagation loss of the radio waves and increase the transmission distance in the ultrahigh frequency bands, beamforming, massive multiple-input multiple-output (massive MIMO), full dimensional MIMO (FD-MIMO), array antenna, analog beam forming, large scale antenna techniques are discussed in 5G communication systems.

In addition, in 5G communication systems, development for system network improvement is under way based on advanced small cells, cloud radio access networks (cloud RANs), ultra-dense networks, device-to-device (D2D) communication, wireless backhaul, moving network, cooperative communication, coordinated multi-points (CoMP), reception-end interference cancellation and the like.

In the 5G system, hybrid FSK and QAM modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have also been developed.

Meanwhile, 3GPP managing a cellular mobile communication standard has named a new core network structure 5G core (5GC) and has been standardizing same in order to push evolution from a conventional 4G LTE system to a 5G system.

5GC may support the following distinguishable functions, compared to an evolved packet core (EPC) that is a network core for the existing 4G.

First, in 5GC, a network slicing function is introduced. According to requirements of 5G, 5GC is required to support various types of terminal (user equipment, UE) types and services. 5GC supports, for example, enhanced mobile broadband (eMBB), ultra-reliable low latency communications (URLLC), and massive machine type communications (mMTC). Such terminals/services require different requirements from a core network. For example, eMBB service requires a high data rate, and URLLC service requires a high stability and a low latency. One of techniques provided to satisfy these various service requirements is network slicing.

Network slicing is a method of virtualizing one physical network to create several logical networks, and each network slice instance (NSI) may have different characteristics. Therefore, each NSI may have a network function (FN) according to the characteristic thereof, and thus various service requirements may be satisfied. An NSI suitable for the characteristic of a required service is assigned to each terminal, so that various 5G services may be efficiently supported.

Second, 5GC may easily support a network virtualization paradigm by separating a mobility management function and a session management function. In 4G LTE, in order to be provided with a service, all terminals are required to exchange signaling with a single core equipment, which is a mobility management entity (MME) serving as registration, authentication, mobility management, and session management functions. However, in 5G, the number of terminals has grown explosively, and mobility and traffic/session characteristics required to be supported are subdivided according to the types of terminals. Accordingly, if a single equipment, such as a MME, supports all functions, decrease in scalability indicating the addition of an entity for each required function is inevitable. Therefore, various functions have been developed based on a structure of separating a mobility management function from a session management function in order to improve scalability in terms of signaling loads and the functions/implementation complexity of core equipment responsible for a control plane.

Recently, there is an emergence of an edge computing system. In an edge computing system, a user equipment (UE) may establish a data connection to an edge data network (EDN) located close to the UE and be provided with an edge computing service so as to use a low latency or broadband service. Such an edge computing service may be provided through an edge application server (EAS) that is operated in an edge computing platform or an edge hosting environment being operated in an edge enabler server (EES) of a particular edge data network. That is, a UE may be provided with an edge computing service from an edge application server (EAS) which is most adjacent to an area in which the UE is located.

The present disclosure provides a method and an apparatus for searching (for example, discovering) for and obtaining an edge application server which is capable of using a function of an application with which an edge application server has federated, when a terminal moves.

In addition, the present disclosure provides an apparatus and an operation for, when an edge application server providing a federation function is re-executed, notifying reusability and validity of information on edge computing service-related federated servers which have been previously connected thereto.

In addition, the present disclosure provides a method for searching for a valid edge application server when an edge application server for providing a federation function fails to be discovered.

In addition, the present disclosure provides a federation context processing method for providing, to an edge application server by an application enabler server, an element (e.g., a federated EAS indicator and available EAS APIs) enabling identification of services of an edge application server providing a federation function and an available federated application server, and federated edge application server information (edge application server profile, e.g., edge application server address/service area/status/service KPI).

In addition, the present disclosure provides a terminal signaling minimization method for re-obtaining edge application information and edge computing setting information of a terminal when the information is updated.

According to an embodiment, a method performed by an edge enabler server (EES) in a wireless communication system supporting edge computing includes: receiving, by the EES, a registration request message including a federated edge application server identifier from an edge application server (EAS); providing valid federated EAS information for the EAS to an EAS; selecting, by the EES, a method for providing EAS information allowing use of a federated EAS to the EAS; and performing an operation based on the selected providing method to provide the federated EAS information.

In addition, according to an embodiment, an edge enabler server (EES) in a wireless communication system supporting edge computing includes: a transceiver; and a processor configured to receive, via the transceiver, a registration request message including a context of a federated edge application sever not configured in the EES, select a method for providing federated EAS information for the EAS, and perform an operation based on the selected providing method to provide the EAS information to a terminal.

The present disclosure provides a context relocation method for continuously providing a federated service of an edge application server when a terminal moves. The disclosure provides a method for searching for an edge application server providing a federation function. The disclosure provides a method for, when an edge application server providing a valid federation function does not exist in the same edge data network, requesting a search to a different edge data network. The disclosure provides a method for identifying an edge application server providing a federation function by an edge computing service entity. The disclosure provides a method for storing and providing a valid federated edge application server list. A corresponding situation may occur according to a positional distributed arrangement characteristic of an edge computing server, and mobility of a terminal.

FIG. 1 illustrates a wireless communication system according to various embodiments of the present disclosure. A wireless communication system illustrated in FIG. 1 includes an edge computing system 100 and a 5G system 140.

Referring to FIG. 1, the edge computing system may include edge servers 102 and 106, a user equipment 104, a configuration server 108, and a domain name system (DNS) server 110.

Each of the edge servers 102 and 106 is a server which the UE 104 accesses to use a mobile edge computing (MEC) service. A third application server provided by a third party may be operated in each of the edge servers 102 and 106. The edge servers 102 and 106 correspond to edge data networks (EDNs) 120, respectively. Each of the edge servers 102 and 106 may include at least one edge enabler server (EES) and at least one edge application server (EAS).

The configuration server 108 is an initial access server via which the UE 104 may be provided with setting information for use of an MEC service. The configuration server 108 may perform a function for transferring setting information for use of the MEC service to the UE 104. The configuration server 108 is aware of location-specific deployments of the edge servers 102 and 106. Accordingly, the UE 104 may access the configuration server 108 before using the MEC service, and be provided with configuration information required for use of the MEC service, for example, information of the edge server 102 and 106 required to be accessed at a particular location. The configuration server corresponds to an edge configuration server (ECS).

The DNS server 110 may be used to resolve an Internet protocol (IP) address of the edge server 102 and 106, or resolve an IP address of an application server operated in a higher layer of the edge server 102 and 106. That is, the DNS server 110 may be a network function which is aware of information on the edge server 102 and 106 or information of an application server operated in a higher layer of the edge server 102 and 106. The DNS server 110 may exist every edge data network (EDN) 120 covering a particular area, or one DNS server may exist over the entire edge computing system. In case that the DNS server 110 for MEC exists and the edge data network 120 covers a particular area, the UE 104 is required to recognize information of a DNS for a corresponding location. In case that one DNS server 110 exists over the entire edge computing system, the DNS server 110 may be required to recognize server information of the edge servers 102 and 106 arranged in the entire network and information about application servers that the edge computing system is able to provide, and the corresponding information may be provided by the edge servers 102 and 106 to the DNS server 110.

The UE 104 is a device used by a user and communicates with a 5G-RAN 142 through a wireless channel. In some cases, the UE 104 may be operated without involvement of a user. That is, the UE 104 is a device that performs machine-type communication (MTC), and may not be carried by a user. The UE 104 may be called, other than a UE, “a terminal,” “a mobile station,” “a subscriber station,” “a remote terminal,” “a wireless terminal,” “a user device,” or other terms having a technical meaning equivalent thereto.

In addition, the 5G system may include the 5G-radio access network (RAN) 142, a user plane function (UPF) 144, an access and mobility management function (AMF) 146, a session management function (SMF) 148, a policy and charging function (PCF) 150, and a network exposure function (NEF) 152. The AMF 146 is a network function for managing mobility of the UE 104. The SMF 148 is a network function for managing packet data network (PDN) connection provided to the UE. The connection may be called a protocol data unit (PDU) session. The PCF 150 is a network function for applying a service policy of a mobile communication service provider for a UE, a charging policy, and a policy for a PDU session.

The NEF 152 is able to access information for managing the UE in a 5G network, and thus may subscribe for a mobility management event of the corresponding UE, subscribe for a session management event of the corresponding UE, request session-related information, configure charging information of the corresponding UE, request change of a PDU session policy for the corresponding terminal, and transmit small data to the UE. The 5G-RAN 142 means a base station that provides a wireless communication function to the UE. The UPF 144 may perform a gateway function of transferring a packet transmitted or received by the UE. The UPF 144 may be located close to the edge server 106 to support MEC, and thus transfer a data packet to the edge data network 120 thereby accomplishing low latency transmission. The UPF 144 may also be connected to a data network 130 connected to the Internet.

Accordingly, the UPF 144 may route, to the data network 130, data required to be transferred to the Internet among pieces of data transmitted by the UE. In addition, although not illustrated in FIG. 1, the 5G system may further include a unified data management (UDM). The UDM indicates a network function of storing information on a subscriber.

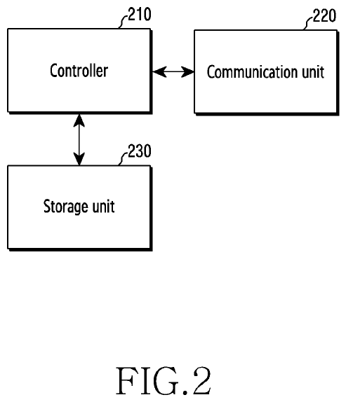

FIG. 2 illustrates a configuration of a network entity in a wireless communication system according to various embodiments of the present disclosure. The configuration illustrated as an example in FIG. 2 may be understood as a configuration of each of network entities configuring the edge computing system 100 and the 5G system 140 in FIG. 1. Specifically, a network entity to which the configuration illustrated as an example in FIG. 2 may be applied includes at least one of a terminal (UE), an edge server, an edge enabler server (EES), an edge application server (EAS), an edge configuration server (ECS), a DNS server, a 5G-RAN, a UPF, an AMF, an SMF, a PCF, and an NEF. In addition, a network entity to which the configuration illustrated as an example in FIG. 2 may be applied may include other entities configuring the edge computing system and the 5G system.

The term “ . . . unit” or the ending of a word, such as “ . . . or,” “ . . . er,” or the like used hereinafter may indicate a unit of processing at least one function or operation, and this may be embodied by hardware, software, or a combination of hardware and software.

Referring to FIG. 2, a network entity includes a communication unit 210, a storage unit 220, and a controller 230.

The communication unit 210 provides an interface for performing communication with other devices within a network. The communication unit 210 may be called a modem, a transmitter, a receiver, or a transceiver.

The storage unit 220 stores data such as a basic program, an application program, and setting information for an operation of the network entity. The storage unit 220 may be configured as a volatile memory, a nonvolatile memory, or a combination of a volatile memory and a nonvolatile memory. The storage unit 220 provides stored data according to a request of the controller 230.

The controller 230 controls overall operations of the network entity. For example, the controller 230 transmits or receives a signal via the communication unit 210. In addition, the controller 230 records and reads data in and from the storage unit 220. To this end, the controller 230 may include at least one processor. According to various embodiments, the controller 230 may control the network entity to perform operations according to various embodiments described later.

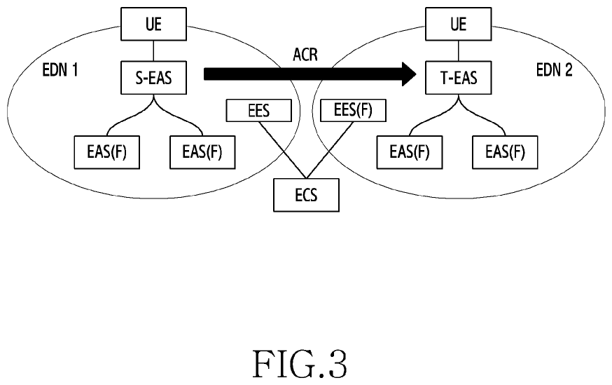

FIG. 3 illustrates a method for maintaining a federated EAS (EAS(F)) service session in a different edge data network (EDN) when application context relocation (ACR) occurs due to mobility of a terminal in wireless communication system according to various embodiments of the present disclosure. An edge enabler layer is required to relocate not only a terminal context of an EAS but also a context of an EAS(F) providing a federation function to the EAS. FIG. 3 shows a method for searching for a T-EAS which is able to use an EAS(F) providing a federation function, so as to be provided with a federation function from an available EAS(F) in a new EDN.

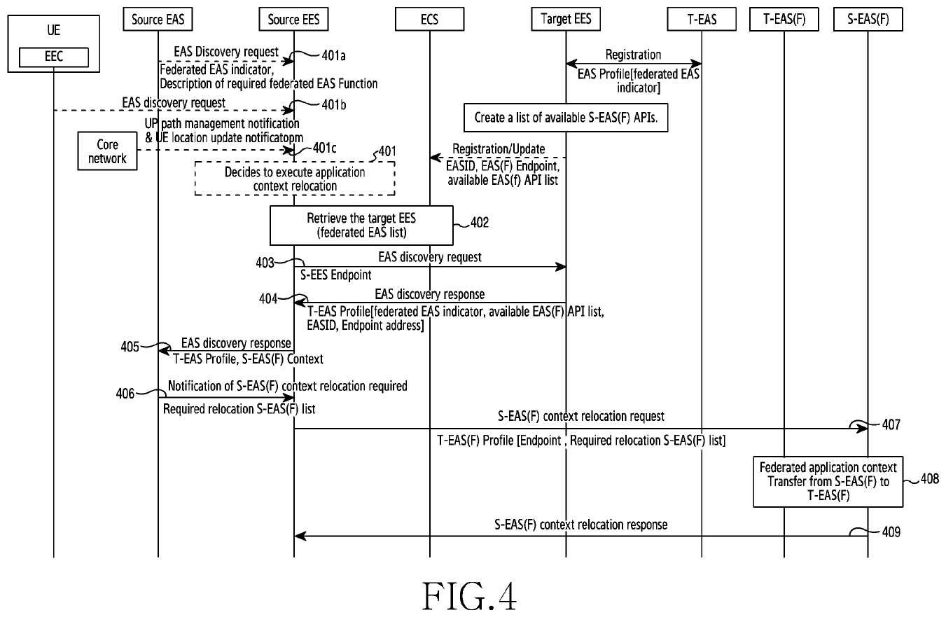

FIG. 4 illustrates an example of a procedure of an EES to obtain a target EAS (hereinafter, T-EAS) supporting a federated EAS and provide a federated EAS context to a source EAS (hereinafter, S-EAS) in a wireless communication system according to various embodiments of the present disclosure.

Referring to FIG. 4, an EAS providing a federation function may be instantiated and then transmit a registration request message to an EES so as to provide a service to an EDN. The EAS registration request message transmitted from the EAS may include a federated EAS indicator which is an identifier indicating an EAS providing a federated EAS function. An S-EAS and a T-EAS may be instantiated and then registered in an S-EES and a T-EES, respectively.

When the T-EES requests an ECS for a registration or to update EES information, the T-EES may transmit a request message including an EASID, an EAS(F) endpoint, and an available API list of a federated EAS(F) used by the T-EES.

Referring to FIG. 4, the source EES (S-EES) may trigger a procedure of searching for a T-EAS to continuously provide a federation function to an edge enabler layer through an ACR procedure, by determining, by the S-EES, execution of application context relocation (hereinafter, ACR) in operation 401, or by receiving a message of operations 401a, 401b, and 401c. Each trigger operation is as follows.

In operation 401a, the S-EAS may transmit an EAS discovery request message to the source EES to discover the T-EAS. The discovery request message may include a federated EAS indicator and a required federated EAS function descriptor of the S-EAS.

In operation 401b, an edge enabler client (EEC) in a terminal may determine ACR and transmit an EAS discovery request message to the S-EES.

In operation 401c, a core network may transmit a terminal location update notification or a user plane path management notification to the EES. The EES may receive a corresponding request to determine ACR execution.

When the message of operation 401a or operation 401b is transmitted or ACR execution is determined, the S-EES may retrieve T-EES information from the ECS to search for a corresponding T-EAS.

In operation 402, the EES may receive T-EES information from the ECS to search for a T-EAS. T-EAS information on a T-EAS providing a federation function may be registered in the ECS. The corresponding information may be previously configured by an edge service provider as an EAS list distinguished by a federated EAS indicator, or may be provided to the ECS by registration/update of the S-EES.

If the corresponding information does not exist in the ECS, the ECS may request a federated EAS list from an ECS available at a location to which the terminal moves.

The S-EES may identify a federated EAS indicator of an EAS registered in the S-EES, and a federated EAS list of the T-EES stored in the ECS, and use same as T-EES information of a T-EES to be selected by the S-EES.

In operation 403, the S-EES may transmit an EAS discovery request to the selected T-EES. The message may include an S-EES endpoint.

In operation 404, the T-EES may transmit a response message for the EAS discovery message, which includes T-EAS information (federated EAS indicator, available EAS(F) API list, EASID, and endpoint address of the T-EAS) registered in the T-EES.

In operation 405, the S-EES may transmit an EAS discovery response message to the S-EAS. The EAS discovery response message may include an S-EAS(F) context and the T-EAS information (federated EAS indicator, available EAS(F) API list, EASID, and endpoint address of the T-EAS).

In operation 406, the S-EAS may provide a federated EAS list requiring context relocation to the S-EES. In an embodiment, the S-EAS may transmit an S-EAS(F) context relocation request, based on the S-EAS(F) context and the T-EAS information received from the S-EES.

In operation 407, the S-EES may identify a T-EAS Profile and an S-EAS(F) list received from the S-EAS, and transmit, to each S-EAS(F) requiring context relocation, a context relocation request message including information of a T-EAS(F) profile (federated EAS indicator, available EAS(F) API list, EASID, and endpoint address). In an embodiment, a T-EAS(F) may receive an S-EAS(F) context from the S-EAS(F) having received an S-EAS(F) context relocation request.

In operation 408, the S-EAS(F) may identify the T-EAS(F) profile included in the corresponding message. The S-EAS(F) may identify, for service continuity, an T-EAS(F) address usable by a T-EAS to be connected later, and provide the S-EAS(F) context to the T-EAS(F). The provided S-EAS(F) context may include an available EAS API list. The T-EAS(F) having received the S-EAS(F) context may provide a continuous federation function to the T-EAS. Which method is used to provide a context deviates from the technical range of the disclosure.

In operation 409, the S-EAS(F) may transmit a context relocation response message including a context relocation result to the S-EES.

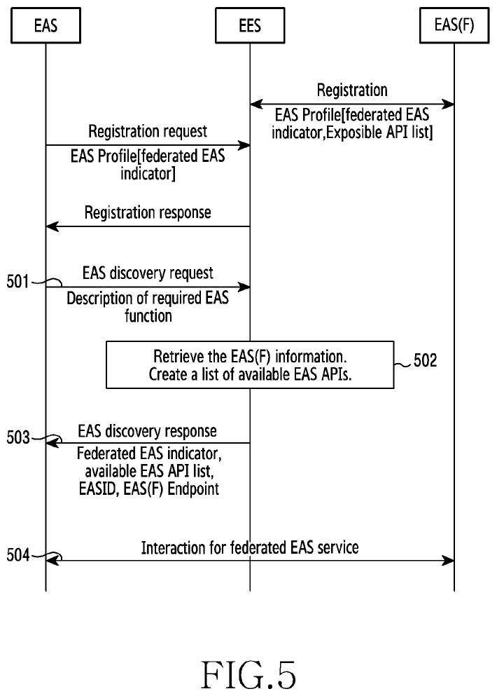

FIG. 5 illustrates an example of a procedure of an EES to obtain an EAS (F) supporting a federated EAS and provide a federated EAS context to an EAS in a wireless communication system according to various embodiments of the present disclosure.

Referring to FIG. 5, an EAS providing a federation function may be instantiated and then transmit a registration request message to an EES so as to provide a service to an EDN. The EAS registration request message transmitted from the EAS may include an exposable API list and a federated EAS indicator which is an identifier indicating an EAS providing a federated EAS function.

In operation 501, an EAS may transmit an EAS(F) discovery request message to an EES to use a function of a federated EAS. The corresponding message may include an EAS function descriptor related to an EAS function needed by the EAS.

In operation 502, the EES may identify the corresponding request message to search for an EAS which is capable of providing a federated function to the EAS having transmitted the request message, from EAS information registered in the EES, and generate an API list usable by the found EAS.

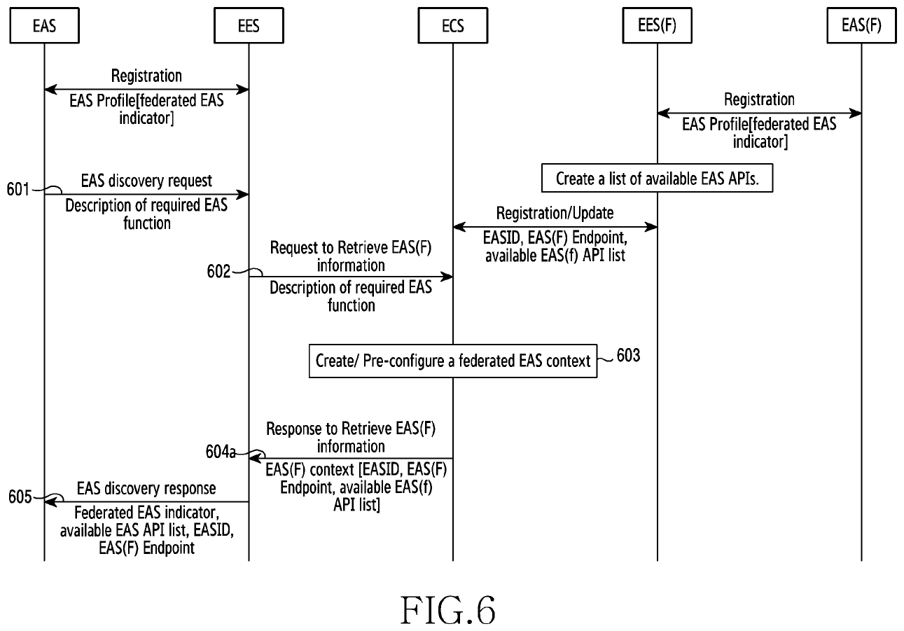

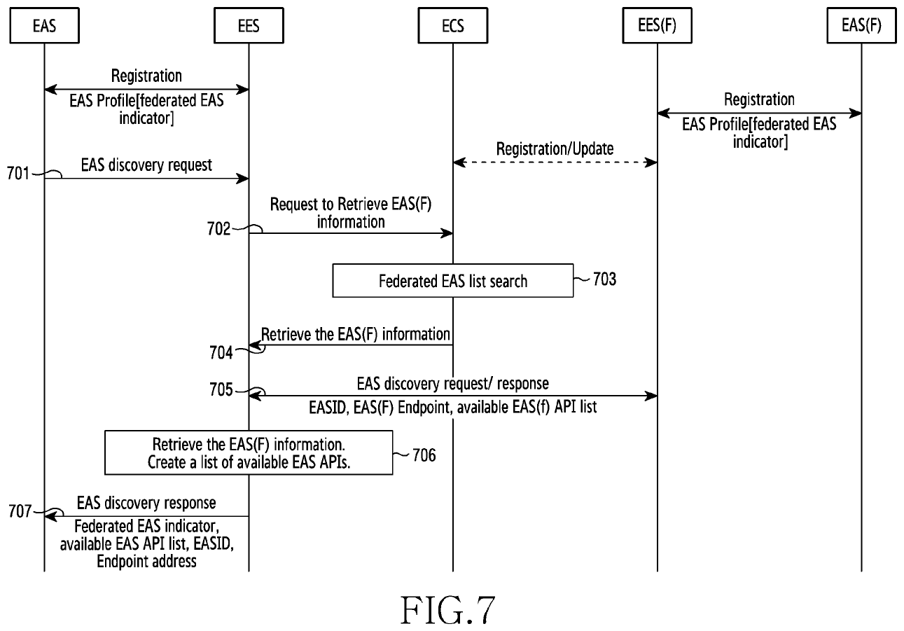

When the corresponding EAS information does not exist, the EES may obtain federated EAS information by using the embodiments of FIG. 6 and FIG. 7 described later.

In operation 503, the EES may transmit a response message for the EAS discovery request message, which includes an EAS(F) context (federated EAS indicator, available EAS API list, EASID, and endpoint address). The EAS may receive a service of the EAS(F) by using an EAS address and an available API of the message.

In operation 504, the EAS and the EAS(F) operate for a federated EAS service in an interworking manner.

FIG. 6 illustrates an example of a procedure of an EES to obtain an EAS (F) supporting a federated EAS and provide a federated EAS context to an EAS in a wireless communication system according to various embodiments of the present disclosure.

Referring to FIG. 6, an EAS providing a federation function may be instantiated and then transmit a registration request message to an EES so as to provide a service to an EDN. The EAS registration request message transmitted from the EAS may include a federated EAS indicator which is an identifier indicating an EAS providing a federated EAS function.

In operation 601, an EAS may transmit an EAS(F) discovery request message to an EES to use a function of a federated EAS. The corresponding message may include an EAS function descriptor related to an EAS function needed by the EAS.

In operation 602, when there is no EAS that is capable of providing a federation function of the corresponding request among EASs registered in the EES, the EES may transmit a federated EAS configuration information provision request message to an ECS.

The EES may generate an EAS API list exposable by an EAS(F) providing a federation function, and may store same in the ECS. The EES may register and update, in the ECS, an EASID, an EAS(F) endpoint, and an available EAS(f) API list.

In operation 603, the ECS having received the corresponding request may generate an EAS(F) context including EAS information (EASID, EAS(F) endpoint, and available EAS(f) API list) of an EES registered in the ECS, or including a federated EAS list previously configured in the ECS by an edge service provider.

In operation 604, the ECS may transmit a response message for the federated EAS configuration information provision request message of the EES, the response message including the EAS(F) context (EASID, EAS(F) endpoint, and available EAS(f) API list).

In operation 605, the EES may transmit a response message for the EAS discovery request message, which includes an EAS(F) context (federated EAS indicator, available EAS API list, EASID, and EAS(F) endpoint). The EAS may receive a service of an EAS(F) by using an EAS address and an available API of the message.

FIG. 7 illustrates an example of a procedure of an EES to obtain an EAS (F) supporting a federated EAS and provide a federated EAS context to an EAS in a wireless communication system according to various embodiments of the present disclosure.

Referring to FIG. 7, an EAS providing a federation function may be instantiated and then transmit a registration request message to an EES so as to provide a service to an EDN. The EAS registration request message transmitted from the EAS may include a federated EAS indicator which is an identifier indicating an EAS providing a federated EAS function.

In operation 701, an EAS may transmit an EAS(F) discovery request message to an EES to use a function of a federated EAS.

In operation 702, when there is no EAS that is capable of providing a federation function of the corresponding request among EASs registered in the EES, the EES may transmit a federated EAS configuration information provision request message to an ECS.

In operation 703, the ECS searches a federated EAS list.

In operation 704, when there is no EAS that is capable of providing a federation function of the corresponding request among EASs registered in the EES, the EES may receive federated EES (EES(F)) information from the ECS.

The ECS may provide, to the EES, EES(F) information (EESID and EES Endpoint) providing a federation function among EESs registered in the ECS, together with a federated EAS indicator.

In operation 705, the EES may transmit an EAS discovery request message including the federated EAS indicator to the EES(F) received from the ECS. The EES(F) may include EAS(F) information registered in the EES(F) in a response message, and transmit same as a response message for the request message of the EES.

In operation 706, the EES may search for an EAS capable of providing a federation function to the EAS having transmitted the request message from EAS information received from the EES(F), and generate an API list usable by the found EAS.

In operation 707, the EES may transmit a response message for the EAS discovery request message (for example, the response message is received from the EES(F)), the response message including an EAS(F) context (federated EAS indicator, available EAS API list, EASID, and endpoint address). The EAS may receive a service of an EAS(F) by using an EAS address and an available API of the message.

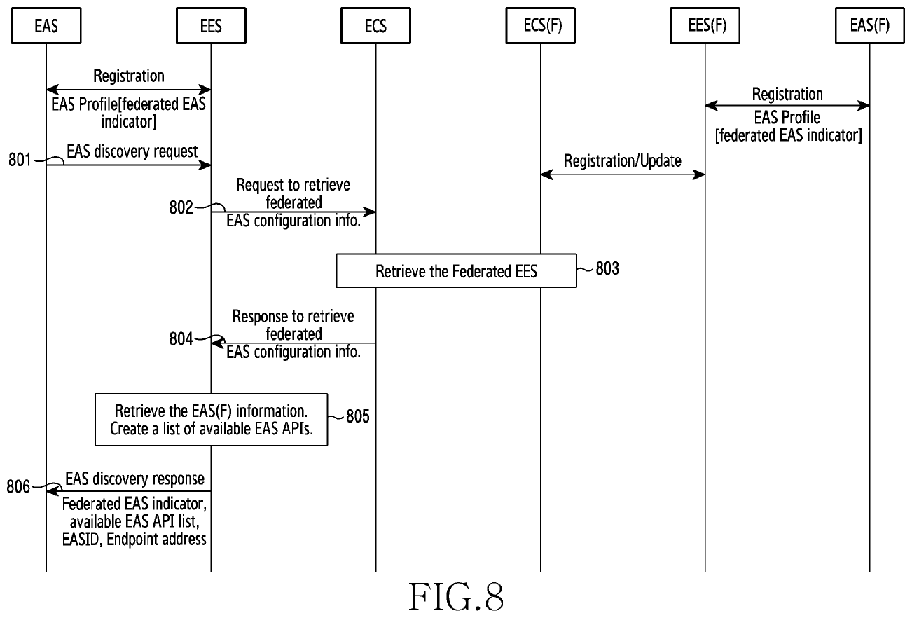

FIG. 8 illustrates an example of a procedure of an EES to obtain an EAS (F) supporting a federated EAS and provide a federated EAS context to an EAS in a wireless communication system according to various embodiments of the present disclosure.

Referring to FIG. 8, an EAS providing a federation function may be instantiated and then transmit a registration request message to an EES so as to provide a service to an EDN. The EAS registration request message transmitted from the EAS may include a federated EAS indicator which is an identifier indicating an EAS providing a federated EAS function.

In operation 801, an EAS may transmit an EAS(F) discovery request message to an EES to use a function of a federated EAS.

In operation 802, when there is no EAS that is capable of providing a federation function of the corresponding request among EASs registered in the EES, the EES may transmit a federated EAS configuration information provision request message to an ECS. That is, when there is no EAS that is capable of providing a federation function of the corresponding request among EASs registered in the EES, the EES may receive federated EES information from the ECS.

In operation 803, when there is no EAS that is capable of providing a federation function of the corresponding request among EASs registered in the EES, the ECS may receive federated EAS information from a federated EES. Accordingly, the ECS searches a federated EES list. The ECS may receive federated EAS information from a federated EES.

When there is no EES(F) information (EESID and EES endpoint) providing a federation function among EESs registered in the ECS, the ECS may receive federated EES information from a different ECS providing a federation function. As in the embodiment of FIG. 6 or FIG. 7 described above, a procedure of receiving EAS(F) information from an ECS by an EES may be performed in the same way.

In operation 804, the EES may transmit, to the EES(F), an EAS discovery request message including a federated EAS indicator received from the ECS. The EES(F) may include EAS(F) information registered in the EES(F) in a response message, and transmit same as a response message for the request message of the EES.

In operation 805, the EES may search for an EAS capable of providing a federation function to the EAS having transmitted the request message from EAS information received from the EES(F), and generate an API list usable by the found EAS.

In operation 806, the EES may transmit a response message for the EAS discovery request message received from the EES(F), the response message including an EAS(F) context (federated EAS indicator, available EAS API list, EASID, and endpoint address). The EAS may receive a service of an EAS(F) by using an EAS address and an available API of the message.

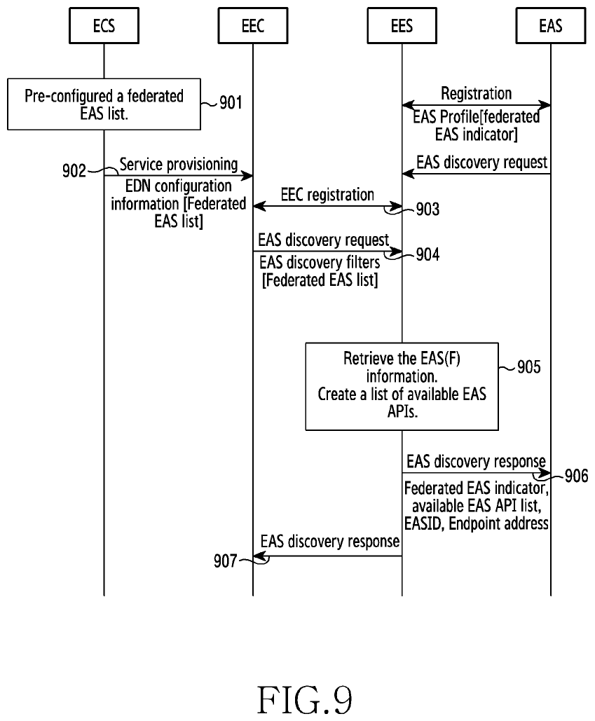

FIG. 9 illustrates an example of a procedure of an EES to obtain an EAS (F) supporting a federated EAS and provide a federated EAS context to an EAS in a wireless communication system according to various embodiments of the present disclosure.

Referring to FIG. 9, an EAS providing a federation function may be instantiated and then transmit a registration request message to an EES so as to provide a service to an EDN. The EAS registration request message transmitted from the EAS may include a federated EAS indicator which is an identifier indicating an EAS providing a federated EAS function.

In operation 901, an edge computing service provider may previously configure an EAS list providing a federation function in an ECS.

In operation 902, the ECS may provision EDN configuration information including a federated EAS list to an EEC.

In operation 903, the EEC may perform EEC registration in an EES.

In operation 904, the EEC may include the EAS list received from the ECS in an EAS discovery request message and provide the same message to the EES.

In operation 905, the EES may identify the corresponding request message to search for an EAS which is able to provide a federated function to the EAS having transmitted the request message, from EAS information registered in the EES, and generate an API list usable by the found EAS.

In operation 906, the EES may transmit a response message for the EAS discovery request message, which includes an EAS(F) context (federated EAS indicator, available EAS API list, EASID, and endpoint address). The EAS may receive a service of an EAS(F) by using an EAS address and an available API of the message.

In operation 907, the EES transmits an EAS discovery response message to the EEC.

According to various embodiments, a method performed by an edge enabler server (EES) in a mobile communication system, the method comprising: receiving, from a first edge application server (EAS), a registration request message including an indicator indicating whether the first EAS provides a federation function; receiving, from the first EAS, a discovery request message for a second EAS, wherein the discovery request message is requested by the first EAS; identifying the second EAS based on the discovery request message; and transmitting, to the first EAS, a discovery response message including context information on the identified second EAS, wherein the context information on the identified second EAS includes an indicator indicating whether the second EAS provides the federation function.

In one embodiment, wherein the method further comprises: transmitting, to an edge configuration server (ECS), a configuration information request message based on the discovery request message; and receiving, from the ECS, the context information on the second EAS based on the configuration information request message.

In one embodiment, wherein the method further comprises: receiving, from the ECS, information on another EES registered with the second EAS; transmitting, to the other EES, the discovery request message for the second EAS; and receiving, from the other EES, the context information on the second EAS.

In one embodiment, wherein the ECS is associated with a first edge data network (EDN), and wherein the context information on the second EAS received from the ECS is provided from an ECS associated with a second EDN different from the first EDN.

In one embodiment, wherein the method further comprises: determining, based on the discovery request message, to perform an application context relocation (ACR) for the second EAS; receiving, from the first EAS, a list of at least one EAS requiring a context relocation based on the context information on the second EAS; and transmitting, to the at least one EAS, a context relocation request message including the context information on the second EAS.

In one embodiment, wherein the method further comprises: receiving, from an edge enabler client (EEC) associated with the first EAS, a message including the context information on the second EAS, wherein the context information on the second EAS included in the message is provided from the ECS.

In one embodiment, wherein the context information on the second EAS includes at least one of an available application programming interface (API) list, identifier (ID) of the second EAS, or an endpoint address of the second EAS.

In one embodiment, wherein the method further comprises: generating, based on the registration request message received from the first EAS, a list of application programming interfaces (APIs) that can be exposed by the first EAS.

In one embodiment, wherein the method further comprises: transmitting, to an edge configuration server (ECS), the list of the APIs that can be exposed by the first EAS.

In one embodiment, wherein the method further comprises: determining whether the context information on the second EAS is registered in the EES based on the discovery request message for the second EAS.

According to various embodiments, an edge enabler server (EES) in a mobile communication system, the EES comprising at least one controller configured to: receive, from a first edge application server (EAS), a registration request message including an indicator indicating whether the first EAS provides a federation function, receive, from the first EAS, a discovery request message for a second EAS, wherein the discovery request message is requested by the first EAS, identify the second EAS based on the discovery request message, and transmit, to the first EAS, a discovery response message including context information on the identified second EAS, wherein the context information on the identified second EAS includes an indicator indicating whether the second EAS provides the federation function.

In one embodiment, wherein the at least one controller is further configured to: transmit, to an edge configuration server (ECS), a configuration information request message based on the discovery request message, and receive, from the ECS, the context information on the second EAS based on the configuration information request message.

In one embodiment, wherein the at least one controller is further configured to: receive, from the ECS, information on another EES registered with the second EAS, transmit, to the other EES, the discovery request message for the second EAS, and receive, from the other EES, the context information on the second EAS.

In one embodiment, wherein the ECS is associated with a first edge data network (EDN), and wherein the context information on the second EAS received from the ECS is provided from an ECS associated with a second EDN different from the first EDN.

In one embodiment, wherein the at least one controller is further configured to: determine, based on the discovery request message for the second EAS, to perform an application context relocation (ACR); receive, from the first EAS, a list of at least one EAS requiring a context relocation based on the context information on the second EAS; and transmit, to the at least one EAS, a context relocation request message including the context information on the second EAS.

In one embodiment, wherein the at least one controller is further configured to: receive, from an edge enabler client (EEC) associated with the first EAS, a message including the context information on the second EAS, wherein the context information on the second EAS included in the message is provided from the ECS.

In one embodiment, wherein the context information on the second EAS includes at least one of an available application programming interface (API) list, identifier (ID) of the second EAS, or an endpoint address of the second EAS.

In one embodiment, wherein the at least one controller is further configured to: generate, based on the registration request message received from the first EAS, a list of application programming interfaces (APIs) that can be exposed by the first EAS.

In one embodiment, wherein the at least one controller is further configured to: transmit, to an edge configuration server (ECS), the list of the APIs that can be exposed by the first EAS.

In one embodiment, wherein the at least one controller is further configured to: determine whether the context information on the second EAS is registered in the EES based on the discovery request message for the second EAS.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by an edge enabler server (EES) in a mobile communication system, the method comprising:
receiving, from a first edge application server (EAS), a registration request message including an indicator indicating whether the first EAS provides a federation function;
receiving, from the first EAS, a discovery request message for a second EAS, wherein the discovery request message is requested by the first EAS;
identifying the second EAS based on the discovery request message; and
transmitting, to the first EAS, a discovery response message including context information on the identified second EAS,
wherein the context information on the identified second EAS includes an indicator indicating whether the second EAS provides the federation function.

2. The method of claim 1, further comprising:
transmitting, to an edge configuration server (ECS), a configuration information request message based on the discovery request message; and
receiving, from the ECS, the context information on the second EAS based on the configuration information request message.

3. The method of claim 2, further comprising:
receiving, from the ECS, information on another EES registered with the second EAS;
transmitting, to the other EES, the discovery request message for the second EAS; and
receiving, from the other EES, the context information on the second EAS.

4. The method of claim 2, wherein the ECS is associated with a first edge data network (EDN), and wherein the context information on the second EAS received from the ECS is provided from an ECS associated with a second EDN different from the first EDN.

5. The method of claim 2, further comprising:
determining, based on the discovery request message, to perform an application context relocation (ACR) for the second EAS;
receiving, from the first EAS, a list of at least one EAS requiring a context relocation based on the context information on the second EAS; and
transmitting, to the at least one EAS, a context relocation request message including the context information on the second EAS.

6. The method of claim 2, further comprising:
receiving, from an edge enabler client (EEC) associated with the first EAS, a message including the context information on the second EAS,
wherein the context information on the second EAS included in the message is provided from the ECS.

7. The method of claim 1, wherein the context information on the second EAS includes at least one of an available application programming interface (API) list, identifier (ID) of the second EAS, or an endpoint address of the second EAS.

8. The method of claim 1, further comprising:
generating, based on the registration request message received from the first EAS, a list of application programming interfaces (APIs) that can be exposed by the first EAS.

9. The method of claim 8, further comprising:
transmitting, to an edge configuration server (ECS), the list of the APIs that can be exposed by the first EAS.

10. The method of claim 1, further comprising:
determining whether the context information on the second EAS is registered in the EES based on the discovery request message for the second EAS.

11. An edge enabler server (EES) in a mobile communication system, the EES comprising at least one controller configured to:
receive, from a first edge application server (EAS), a registration request message including an indicator indicating whether the first EAS provides a federation function;
receive, from the first EAS, a discovery request message for a second EAS, wherein the discovery request message is requested by the first EAS;
identify the second EAS based on the discovery request message; and
transmit, to the first EAS, a discovery response message including context information on the identified second EAS,
wherein the context information on the identified second EAS includes an indicator indicating whether the second EAS provides the federation function.

12. The EES of claim 11, wherein the at least one controller is further configured to:
transmit, to an edge configuration server (ECS), a configuration information request message based on the discovery request message; and
receive, from the ECS, the context information on the second EAS based on the configuration information request message.

13. The EES of claim 12, wherein the at least one controller is further configured to:
receive, from the ECS, information on another EES registered with the second EAS;
transmit, to the other EES, the discovery request message for the second EAS; and
receive, from the other EES, the context information on the second EAS.

14. The EES of claim 12, wherein the ECS is associated with a first edge data network (EDN), and wherein the context information on the second EAS received from the ECS is provided from an ECS associated with a second EDN different from the first EDN.

15. The EES of claim 12, wherein the at least one controller is further configured to:
determine, based on the discovery request message for the second EAS, to perform an application context relocation (ACR);
receive, from the first EAS, a list of at least one EAS requiring a context relocation based on the context information on the second EAS; and
transmit, to the at least one EAS, a context relocation request message including the context information on the second EAS.

16. The EES of claim 12, wherein the at least one controller is further configured to:
receive, from an edge enabler client (EEC) associated with the first EAS, a message including the context information on the second EAS, and
wherein the context information on the second EAS included in the message is provided from the ECS.

17. The EES of claim 11, wherein the context information on the second EAS includes at least one of an available application programming interface (API) list, identifier (ID) of the second EAS, or an endpoint address of the second EAS.

18. The EES of claim 11, wherein the at least one controller is further configured to:
generate, based on the registration request message received from the first EAS, a list of application programming interfaces (APIs) that can be exposed by the first EAS.

19. The EES of claim 18, wherein the at least one controller is further configured to:
transmit, to an edge configuration server (ECS), the list of the APIs that can be exposed by the first EAS.

20. The EES of claim 11, wherein the at least one controller is further configured to:
determine whether the context information on the second EAS is registered in the EES based on the discovery request message for the second EAS.
